(19) United States
(12) Patent Application Publication
(10) Pub. No.: US 2014/0032248 A1
(43) Pub. Date: Jan. 30, 2014

(54) SYSTEMS AND METHODS FOR INSURANCE QUOTE GENERATION, MODIFICATION, APPLICATION, AND ACTIVATION

(71) Applicant: United Services Automobile Association (USAA), San Antonio, TX (US)

(72) Inventors: Lori Holmes, Seguin, TX (US); Robert Eckelbarger, San Antonio, TX (US); Rory Gossling, Boerne, TX (US); Alexandria Gold, San Antonio, TX (US); Jason Shell, San Antonio, TX (US); Francisco Duran, San Antonio, TX (US)

(21) Appl. No.: 13/953,247

(22) Filed: Jul. 29, 2013

Related U.S. Application Data
(60) Provisional application No. 61/676,638, filed on Jul. 27, 2012.

(51) Int. Cl. G06Q 40/08

(52) U.S. Cl. CPC G06Q 40/08
USPC 705/4

(57) ABSTRACT

A system and method for generating, displaying, and modifying an insurance quote that includes a management module in communication with a client device. After the client preferably logs in to the management module, provides relevant information, a calculation engine generates an insurance quote estimate. The quote estimate is preferably displayed on the device even while the client reconfigures the insurance coverage options.

### CROSS REFERENCE TO RELATED APPLICATIONS

This application claims priority to U.S. Application Ser. No. 61/676,638, filed Jul. 27, 2012, which is incorporated herein by reference in its entirety.

### FIELD OF THE INVENTION

The present invention relates to acquiring insurance policy quotes, and more particularly, to generating an insurance policy quote estimate and being able to view the same while re-configuring the policy.

### BACKGROUND OF THE INVENTION

Despite all of the advances in technology, it is still difficult for consumers to get a quote for an insurance policy and be confident that they know what the terms of the policy are, particularly the terms that consumers are typically most concerned with, such as payment and coverage amounts. When the quote is obtained over the phone, the consumers may find it difficult to understand everything being told to them.

Accordingly, there is an unmet need to give consumers the ability to dynamically reconfigure and view insurance options, and couple this with the ability to apply for and activate the insurance.

### SUMMARY OF THE INVENTION

The purpose and advantages of the below described illustrated embodiments will be set forth in and apparent from the description that follows. Additional advantages of the illustrated embodiments will be realized and attained by the devices, systems, and methods particularly pointed out in the written description and the claims herein, as well as from the drawings.

To achieve these and other advantages and in accordance with the purpose of the illustrated embodiments, in one aspect, a system and method for generating, displaying, and modifying an insurance quote, such as a life insurance quote, that includes a management module, preferably running on a server, in communication with a client device, such as a smart phone. The client preferably logs in to the management module, provides personal information, and selects insurance coverage options. A calculation engine in the management module generates an insurance quote estimate, which is displayed on the client device. The client is given the option to reconfigure the insurance coverage options, and while the options are being reconfigured the client can preferably see the insurance quote estimate simultaneously, and the insurance quote estimate is updated if/when the client adjusts the coverage options.

### BRIEF DESCRIPTION OF THE DRAWINGS

So that those having ordinary skill in the art, to which the present illustrated embodiments pertain, will more readily understand how to employ the novel system and methods, certain illustrated embodiments thereof will be described in detail herein-below with reference to the drawings, wherein:

FIG. 1 illustrates a system diagram of an exemplary embodiment of a management system for generating and modifying insurance quotes by users;

FIG. 2 is a flow chart illustrating an exemplary use of the embodiment of FIG. 1;

FIG. 3 is a flow chart illustrating an exemplary process of executing the use depicted in FIG. 2;

FIG. 4 is an illustration of an embodiment of a computing device;

FIG. 5 is a screen shot of an exemplary embodiment depicting a quote estimate overlaying coverage information, shown on a client device;

FIG. 6 is a screen shot of an exemplary embodiment depicting previous insurance policy information, shown on a client device;

FIG. 7 is a screen shot of an exemplary embodiment depicting confirmation of acceptance, shown on a client device; and

FIG. 8 is another screen shot of an exemplary embodiment depicting electronically signing an insurance policy offer, shown on a client device.

### DETAILED DESCRIPTION OF CERTAIN EMBODIMENTS

The below illustrated embodiments are directed to management system and method for generating an insurance quote for a user remotely accessing the system, modifying the quote, and applying for the insurance policy in which a component or a feature that is common to more than one illustration is indicated with a common reference. It is to be appreciated the below illustrated embodiments are not limited in any way to what is shown, as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the certain illustrated embodiments. Furthermore, the terms and phrases used herein are not intended to be limiting but rather to provide an understandable description of the certain illustrated embodiments.

Unless defined otherwise, all technical and scientific terms used herein have the same meaning as commonly understood by one of ordinary skill in the art to relating to below illustrated embodiments. Although any methods and materials similar or equivalent to those described herein can also be used in the practice or testing of the below illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the certain embodiments described herein are preferably utilized in conjunction with a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the certain embodiments described herein. Thus the certain embodiments are not to be understood to be limited by what has been particularly shown and described, except as indicated by the appended claims.

The methods described herein allow users to, in an exemplary use, generate an insurance quote estimate for a policy via their smart phone. The user logs into the server by providing their username and password credentials. The user preferably enters any personal information and selects various insurance policy coverage options. The server generates a quote for the user, which is displayed on the user's smart phone.

The interface on the smart phone then preferably allows the user to modify the insurance policy coverage options while contemporaneously, or near-contemporaneously, seeing how the modifications to the coverage options affect the quote estimate. The user may continue modifying the coverage options as many times and in as many ways as desired. Thus the user can preferably see the relationship between the user's payment requirements and the different insurance coverage options.

After the user is satisfied with the resulting quote estimate, the user can apply for the insurance policy quoted. The application can take the form of submitting the application online, wherein the user may also be required to submit electronic verification that the user is hereby applying for the specified insurance policy. Subsequently, if the user's application is accepted, the user can accept the terms and electronically sign the insurance policy on the user's client device, which is preferably, although not necessarily, a smart phone or tablet.

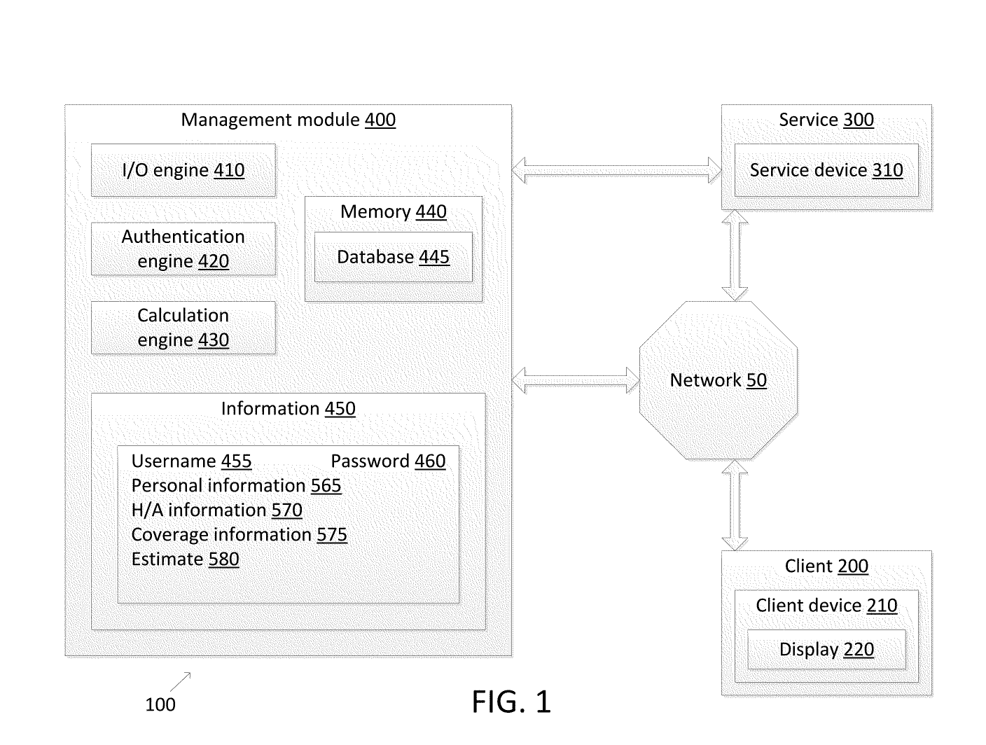

Referring to FIG. 1, a hardware diagram depicting a system 100 in which the processes described herein can be executed is provided for exemplary purposes. In one embodiment, system 100 includes network 50, client 200, service personnel 300, management module 400, and computing device 500. Management module 400 preferably includes I/O engine 410, authentication engine 420, calculation engine 430, memory 440, database 445, and information 450. Information 450 includes username 455, credentials 460, personal information 465, health and activities information 470, coverage information 475, quote estimate 480, previous policy information 485, and signature and agreement 490. Service personnel 300 utilizes service device 310, and client 200 utilizes client device 210 that includes display 220.

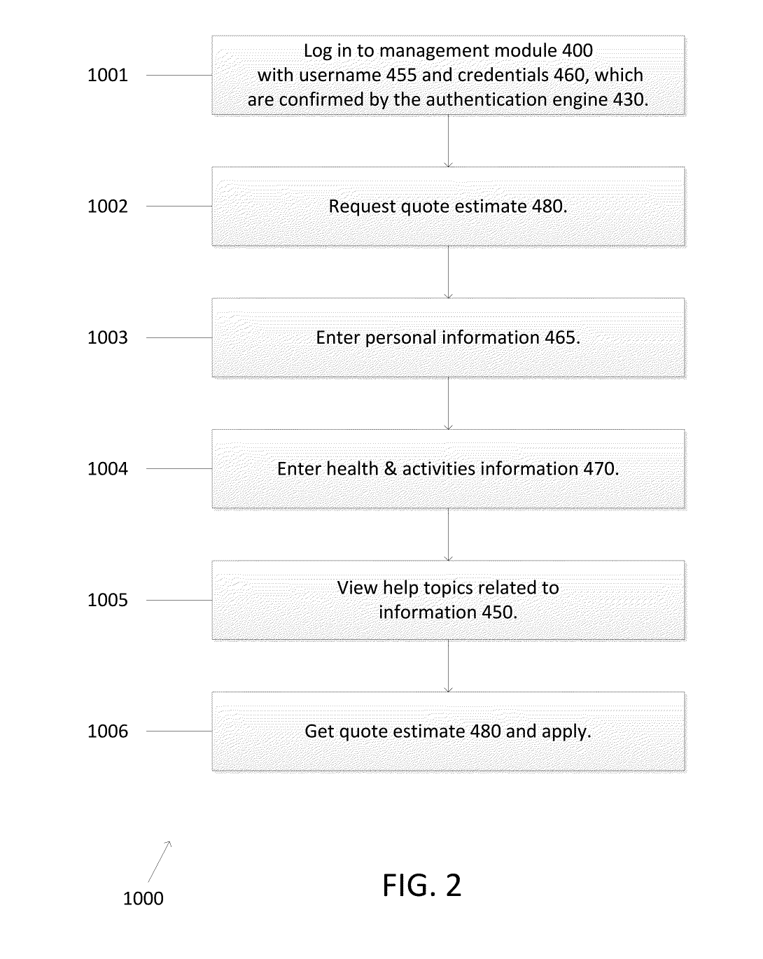

Turning to FIG. 2, in an exemplary process 1000 of utilizing system 100, starting at step 1001, client 200 logs on to management module 400 by utilizing client's 200 username 455 and credentials 460. It is recognized herein that credentials 460 may include a password, a PIN, a file provided for authentication, or any combination thereof. Client 200 is preferably utilizing client device 210, and client device 210 is interacting with I/O engine 410 of management module 400. I/O engine 410 communicates client's 200 username 455 and credentials 460 to authentication engine 420. Authentication engine 420 indicates whether client 200 may proceed.

Subsequently, client 200 requests quote estimate 480 from management module 400 (step 1002). It is recognized herein that process 1000 may start at step 1002 (not shown), wherein client 200 requests quote estimate 480 without having logged in. Client 200 then enters personal information 465 (step 1003), which preferably includes client's 200 age, gender, state or country of residence and/or temporary habitation, military status, rank in military, branch of military, and/or any other related information.

Client 200 then enters health and activities information 470 (step 1004), which preferably includes pending or active deployment orders, membership in military units such as a flight crew, an explosives ordinances and disposal (EOD) team, a demolitions team, or underwater diving unit, any medical condition such as cancer, diabetes, depression, or heart disease, usage of tobacco in previous time frame such as 12 months, family medical conditions such as a parent dying from cardiovascular disease or cancer before the age of 60, and height and weight of client 200.

However, if client 200 has executed step 1001, then information 450 requested during steps 1003 and 1004 may be pre-entered (not shown). In this situation, client 200 may edit information 450 that has been pre-entered.

Client 200 may also view help topics (step 1005) that detail the format and terms used, including clarifying that certain conditions may be excluded from being considered significant medical conditions such as well-controlled high blood pressure, well-controlled cholesterol, allergies, and/or clarifying that certain conditions that may be included as being considered significant medical conditions such as surgery (other than appendix, gall bladder, or minor joint disorder), hospitalization, radiation, multiple daily medications, Multiple Sclerosis, Parkinson's Disease, Post Traumatic Stress Disorder (PTSD), anxiety or depression, tumors, lymphoma, cancer (not including minor skin cancer), melanoma, lupus, emphysema, coronary artery disease, leaky heart valve, disorder or disease of the kidney, liver, throat, esophagus, stomach, intestines, liver, or pancreas, alcoholism, and drug addiction. Help topics in step 1005 preferably also explains the characteristics and differences for various insurance options, such as Level Term Life Insurance, Whole Life Insurance, Universal Life Insurance, and a combination of Whole Life Insurance and Universal Life Insurance.

It is contemplated herein that client 200 may interact with management module 400 in any order of steps, including an order other than that illustrated in FIG. 2. For exemplary purposes only and without limitation, an exemplary interaction between client 200 and management module 400 may include logging in, then reviewing help and the glossary, then requesting a quote estimate, then entering personal information 465 and health and activities information 470 while toggling to and from the help and glossary.

Finally, quote estimate 480 is generated by calculation engine 430 and subsequently client 200 is shown quote estimate 480 on display 220 (step 1006). If client 200 did not log in via step 1001, then process 1000 may require client 200 to log-in via step 1001 before viewing quote estimate 480 (not shown).

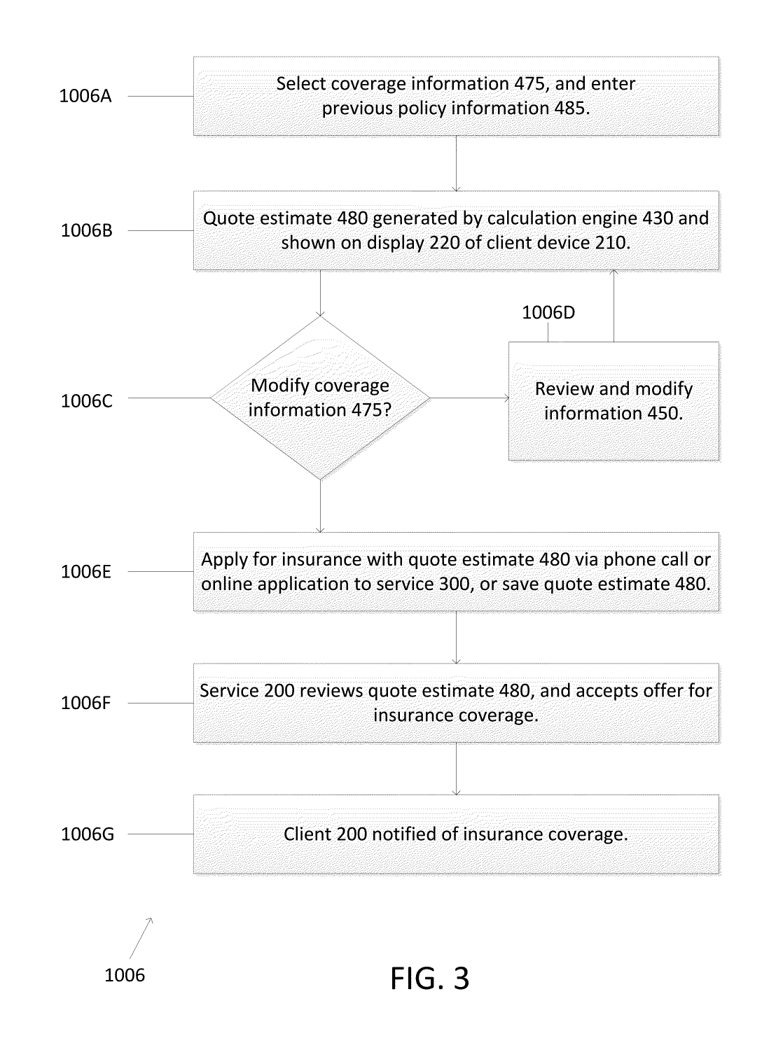

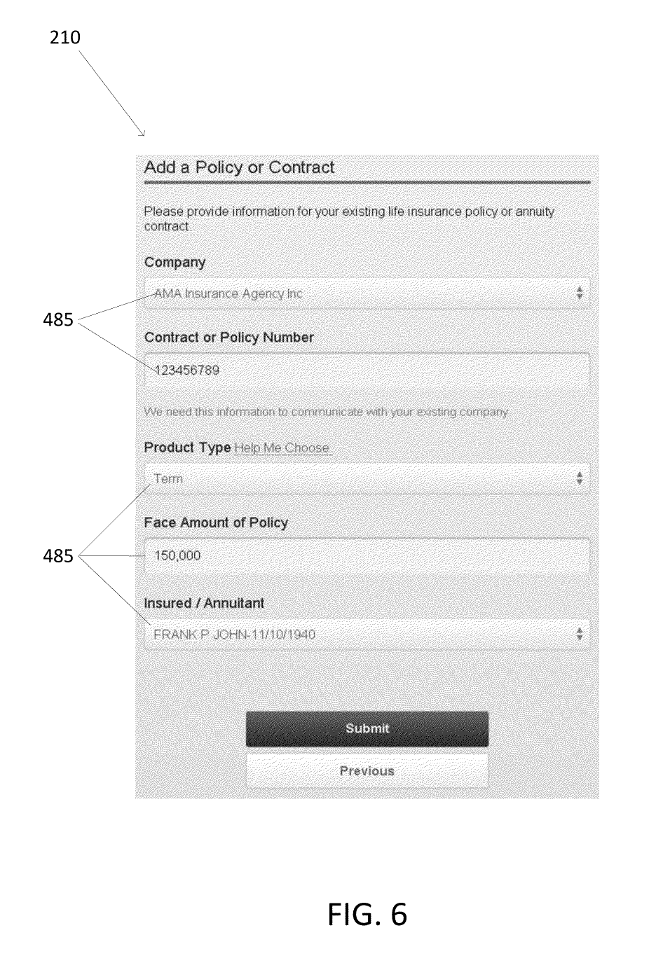

Turning now to FIG. 3, illustrated therein is an exemplary process of executing step 1006 of FIG. 2. Starting at step 1006A, client 200 selects coverage information 475, which preferably includes the type of coverage (e.g., Whole Life), the benefit period (e.g., 30 years), how much coverage is requested (e.g., $250,000.00), payment options such as how the policy will be paid by client 200 (e.g., automatic withdrawal, client 200 mailing a check, etc.) and how often client 200 will need to pay (e.g., monthly). Client 200 further enter previous policy information 485, wherein previous policy information 485 preferably includes the insurance company name, the policy number, the coverage type, the coverage amount, and identifies the insured party (best shown in FIG. 6).

Quote estimate 480 is generated by calculation engine 430 and then shown on display 220 of client device 210 (step 1006B). Subsequently, client 200 determines if client 200 step 1006C) wants to modify coverage information 475, which would preferably modify quote estimate 480; if yes client 200 proceeds to step 1006D, if not client 200 proceeds to step 1006E.

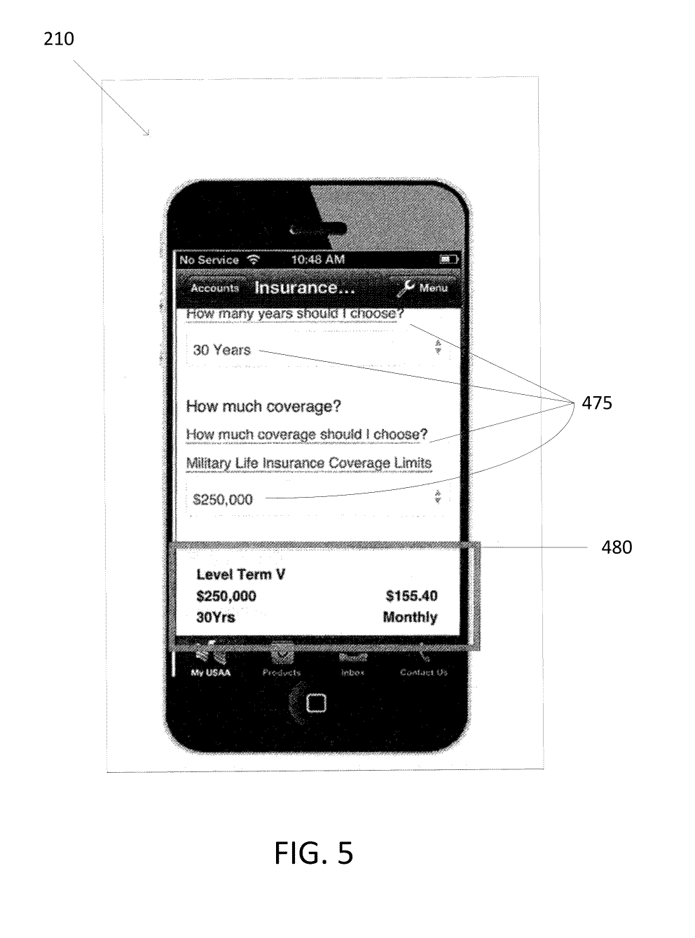

Via step 1006D, while client 200 is modifying coverage information 475, quote estimate 480 is modified and displayed contemporaneously (see FIG. 5). Quote estimate 480 may be displayed, for exemplary purposes only, in a foreground window in front of information 450 (best shown in FIG. 5). With regards to modifications, for example, if client 200 increases the benefit of coverage information 475 by 25%, the periodic payment of quote estimate 480 may also increase by 25% (or any other percentage or amount as deemed appropriate).

It is contemplated herein that quote estimate 480 may be displayed at the bottom of display 220 (as shown in FIG. 5), at the top of display 220, or on either side of display 220. It is further contemplated herein that the information in quote estimate 480 may be arranged differently than shown in FIG. 5, for example, the frequency of the payment (i.e, “Monthly” in FIG. 5) and the client payment amount (i.e., “$155.40” in FIG. 5), may be displayed as “Monthly payments of $155.40.”

Finally, client 200 applies for an insurance policy with quote estimate 480 configuration by calling service 300 or applying online, or client 200 elects to save quote estimate 480 (step 1006E). If client 200 applies online, client 200 may be required to submit further electronic authentication and verification that client 200 is who they are representing themselves to be, and that client 200 thereby agrees to be bound to whatever conditions are expressed at the time.

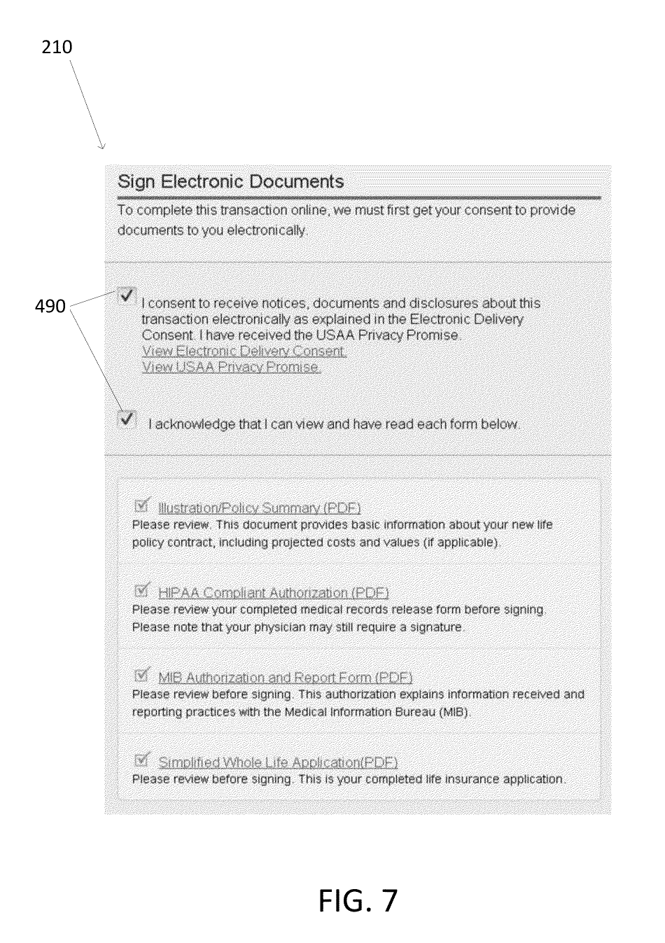

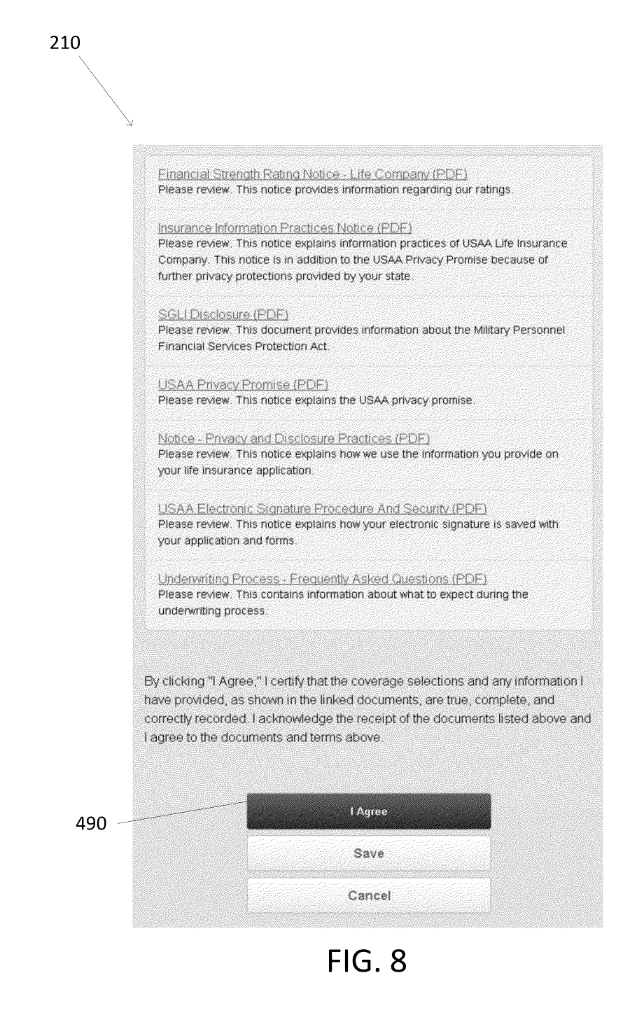

If client 200 applies by calling service 300, service 300 may quickly access information 450, including coverage information 475 and quote estimate 480, via service device 310. Thus, service 300 can answer any questions client 200 may have, or service may quickly allow client 200 to commit to the insurance policy, wherein committing to the insurance policy may include verbally committing to the policy during the call or electronically committing via client device 210 (see FIGS. 7 and 8), either while on the call or any time before or after the call.

After reviewing quote estimate 480 and information 450, including coverage information 475, service personnel 500 may accept the offer for insurance coverage for client 200 (step 1006F). Subsequently, client 200 is notified of insurance coverage (see FIGS. 7 and 8). It is recognized herein that client 200 may merely request an offer for insurance coverage via step 1006F, wherein client 200 accepts an offer from the insurance company. It is also recognized herein that service personnel 500 may propose a counter-offer to client 200, that client 200 may accept. Client 200 accepting the offer for insurance coverage may include client 200 authenticating themselves either verbally over the phone, or electronically, or a combination of both. The electronic confirmation may comprise such steps as the client having to further confirm their identity, and/or it may comprise such steps as the client supplying an electronic signature, wherein the electronic signature is preferably consistent with the laws of the relevant jurisdiction. Further, after the insurance coverage has been agreed upon, information 450 is saved and stored in memory 540 of system 100.

Turning now back to FIG. 2, after client 200 saves quote estimate, when client 200 subsequently interacts with management module 400 via process 1000, after client 200 logs in (step 1001), client 200 is given the option to proceed directly to getting quote estimate 480 (step 1006 in FIG. 2, and process 1006 in FIG. 3).

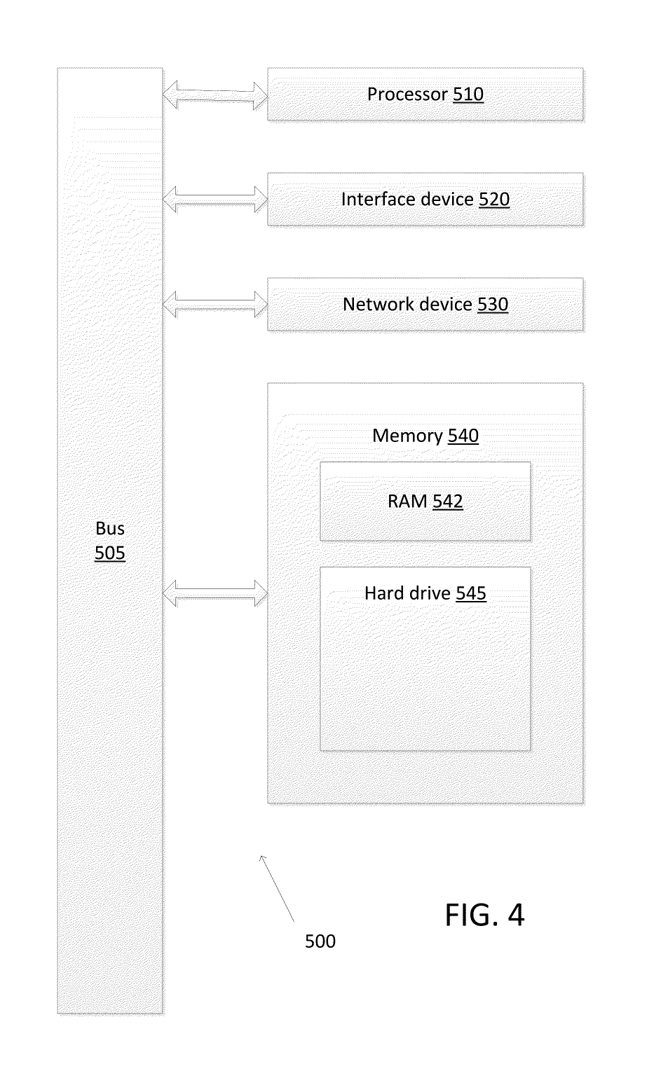

Turning now to FIG. 4, illustrated therein is an exemplary embodiment of computing device 500 that preferably includes bus 505, over which intra-device communications preferably travel, processor 510, interface device 520, network device 530, and memory 540, which preferably includes RAM 542 and hard drive 545.

Client device 210 and service device 310 preferably include computing device 500 and the components thereof. For example, in FIG. 1, client device 210 preferably is a smart phone, such as an iPhone®, that preferably includes most, if not all, of the components of computing device 500. However, it is contemplated herein that client device 210 may be any computing device 500 such as, for exemplary purposes only, a tablet, laptop, or desktop. Also in FIG. 1, service device 310 preferably is a computer such as a tablet, laptop, or desktop that also preferably includes most, if not all, of the components of computing device 500.

The term “module”/“engine” is used herein to denote a functional operation that may be embodied either as a stand-alone component or as an integrated configuration of a plurality of subordinate components. Thus, for example, management module 400 and calculation engine 430 may be implemented as a single module or as a plurality of modules that operate in cooperation with one another. Moreover, although management module 400 and calculation engine 430 are described herein as being implemented as software, they could be implemented in any of hardware (e.g. electronic circuitry), firmware, software, or a combination thereof.

Memory 540 is a computer-readable medium encoded with a computer program. Memory 540 stores data and instructions that are readable and executable by processor 510 for controlling the operation of processor 510. Memory 540 may be implemented in random access memory 542 (RAM), volatile or non-volatile memory, solid state storage devices, magnetic devices, hard drive 545, a read only memory (ROM), or a combination thereof.

Processor 510 is an electronic device configured of logic circuitry that responds to and executes instructions. Processor 510 outputs results of an execution of the methods described herein. Alternatively, processor 510 could direct the output to a remote device (not shown) via network 50.

It is to be further appreciated that network 50 depicted in FIG. 1 can include a local area network (LAN), a wide area network (WAN), a personal area network (PAN), other network configurations, or any combination thereof. Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as storage medium. It is to be appreciated that the illustrated network connections of FIG. 1 are exemplary and other means of establishing a communications link between multiple computers may be used.

It should be understood that computing devices 500 each generally include at least one processor 510, at least one interface device 520, and at least one memory device 540 coupled via buses 505. Computing devices 500 may be capable of being coupled together, coupled to peripheral devices, and input/output devices. Computing devices 500 are represented in the drawings as standalone devices, but are not limited to such. Each can be coupled to other devices in a distributed processing environment. In a preferred embodiment, client device 210, service device 310, and management module each comprise at least one computing device.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “include,” “includes,” “including,” “comprises,” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention as defined by the appended claims.

What is claimed is:

1. A computer implemented method for generating, providing, and modifying insurance quotes, the method comprising:
accessing a server via a client device, the client device having memory, a network device, a display, and a processor;
selecting coverage information for an insurance policy;
receiving a quote estimate for the insurance policy, the insurance policy at least partly based on the coverage information;
viewing the quote estimate; and
modifying the coverage information while simultaneously viewing the quote estimate.

2. The computer implemented method of claim 1, wherein the quote estimate is modified to be consistent with the modified coverage information.

3. The computer implemented method of claim 2, wherein the quote estimate is viewed in a foreground window in front of the coverage information.

4. The computer implemented method of claim 3 further comprising the step of:
applying for an insurance policy by contacting a service team, the insurance policy being at least partially based on the coverage information.

5. The computer implemented method of claim 4 wherein contacting service personnel comprises calling service personnel.

6. The computer implemented method of claim 4 further comprising the step of:
receiving a formal offer for insurance coverage, the offer being based on the coverage information.

7. The computer implemented method of claim 6 further comprising the step of:
accepting the insurance coverage by electronically signing the offer.

8. A insurance generation and modification system comprising:
a server with an interface module, a processor, and memory; and
a client device that communicates with the server, the client device having an interface module, memory, a processor, and a display, wherein the client device sends selected coverage information for an insurance policy to the server, and wherein the client device receives a quote estimate that is at least partly based on the coverage information, and wherein the client device displays the quote estimate when the coverage information is modified.

9. The system of claim 8, wherein the displayed quote estimate is modified to be consistent with the modified coverage information.

10. The system of claim 9, wherein the quote estimate is viewed, on the client device, in a foreground window in front of the coverage information.

11. The system of claim 10, wherein the client device communicates an application for an insurance policy that is at least partially based on the coverage information.

12. The system of claim 11, wherein an offer for insurance coverage is received by the client device, the offer being at least partially based on the coverage information.

13. The system of claim 12, wherein the client device communicates that the offer has been signed and accepted.

14. A non-transitory computer readable storage medium and a computer program embedded therein, the computer program comprising instructions, which when executed by a computer system cause the computer system to:
access a server via a client device, the client device and the server each having memory, a network device, and a processor, and the client device further having a display;
configure coverage information for an insurance policy;
receive a quote estimate for the insurance policy, the insurance policy at least partly based on the coverage information;
display the quote estimate; and
modify the coverage information while simultaneously displaying the quote estimate on the client device's display.

15. The non-transitory computer readable storage medium of claim 14, wherein the quote estimate is modified to be consistent with the modified coverage information.

16. The non-transitory computer readable storage medium of claim 15, wherein the quote estimate is viewed, on the client device, in a foreground window in front of the coverage information.

17. The non-transitory computer readable storage medium of claim 16, further comprising instructions, which when executed by the computer system, further cause the computer system to:
apply for an insurance policy by contacting service personnel, the policy being at least partially based on the coverage information.

18. The non-transitory computer readable storage medium of claim 17, wherein contacting service personnel comprises initiating a phone call to service personnel.

19. The non-transitory computer readable storage medium of claim 18, further comprising instructions, which when executed by the computer system, further cause the computer system to:
send a formal offer for insurance coverage from the server, the offer being based on the coverage information.

20. The non-transitory computer readable storage medium of claim 19, further comprising instructions, which when executed by the computer system, further cause the computer system to:
accept the insurance coverage by electronically signing the offer.
